(19) United States
(12) Patent Application Publication
(10) Pub. No.: US 2022/0366462 A1
(43) Pub. Date: Nov. 17, 2022

(54) RECOMMENDATION SYSTEM, AND PRODUCT RECOMMENDATION METHOD

(71) Applicant: Hitachi, Ltd., Tokyo (JP)

(72) Inventors: Toshiyuki NAKAMURA, Tokyo (JP); Koji UTSUMI, Tokyo (JP); Noriyuki HAGA, Tokyo (JP); Tetsuro ADACHI, Tokyo (JP)

(73) Assignee: Hitachi, Ltd., Tokyo (JP)

(21) Appl. No.: 17/670,965

(22) Filed: Feb. 14, 2022

(30) Foreign Application Priority Data
May 17, 2021 (JP) 2021-083025

(51) Int. Cl. G06Q 30/02

(52) U.S. Cl. CPC G06Q 30/0282; G06Q 30/0201

(57) ABSTRACT

It is provided a recommendation system for selecting a product to be proposed to a client, the recommendation system comprising: an arithmetic device configured to execute predetermined processing; and a storage device accessible to the arithmetic device; having a selection module configured to estimate a product to be recommended to a client, the selection module being configured to: calculate a change ratio at which, out of pieces of collected field information, a specific piece of field information changes; extract a business organization high in the change ratio of the specific piece of field information as a target client; and estimate, from similarity in the change of the field information of the client, a product to be recommended to the target client.

### CLAIM OF PRIORITY

The present application claims priority from Japanese patent application number. 2021-083025 filed on May 17, 2021, the content of which is hereby incorporated by reference into this application.

### BACKGROUND OF THE INVENTION

This invention relates to a solution recommendation system for providing assistance with proposal of a solution to a business organization.

In a B to B sales activity between one business and another business, a person handling sales may fail to fully grasp situations and problems of a client and miss optimum timing to approach the client for sales. Particularly nowadays, a person handling sales visits a client less often and, consequently, grasping of the client's situations and problems is even more difficult. Meanwhile, digitization of 4M (Man, Machine, Method, and Material) data and other types of field data is advancing owing to propagation of DX and IoT. On the other hand, past sales data and clients' digital data are not being utilized in sales activities to the fullest.

Background art in this technical field includes the following related art. In JP 2020-86954 A, there is described an information processing system including change ratio information obtaining means for obtaining change ratio information indicative of a change ratio in a capacity utilization amount of a machine, product information storage means for storing product information, recommendation condition storage means for storing a condition for recommending a product from the product information based on the change ratio information, and recommended product determination means for determining a recommended product based on the change ratio information and the recommendation condition.

### SUMMARY OF THE INVENTION

In order to enable a person handling sales to grasp situations of a client in real time without visiting the client's field site and present a proposal required by the client at optimum timing under the circumstance described above, estimation of the client's problem through utilization of data collected from the client's field site (factory) and estimation of a solution for solving the client's problem are demanded. In manufacturing industries, in particular, it is required to collect, in real time, changes in field production situation detected from 4M data including information about movement of machines and people and about materials, and estimate a problem and a solution from those changes.

An object of this invention is to achieve a solution recommendation system which collects changes in field situation in real time and which estimates a problem and a solution.

The representative one of inventions disclosed in this application is outlined as follows. There is provided a recommendation system for selecting a product to be proposed to a client, the recommendation system comprising: an arithmetic device configured to execute predetermined processing; and a storage device accessible to the arithmetic device; having a selection module configured to estimate a product to be recommended to a client, the selection module being configured to: calculate a change ratio at which, out of pieces of collected field information, a specific piece of field information changes; extract a business organization high in the change ratio of the specific piece of field information as a target client; and estimate, from similarity in the change of the field information of the client, a product to be recommended to the target client.

According to the at least one aspect of this invention, the problem and the solution of the client can be estimated. Problems, configurations, and effects other than those described above are clarified by the following description of at least one embodiment of this invention.

### BRIEF DESCRIPTION OF THE DRAWINGS

FIG. 1 is a block diagram for illustrating a logical configuration of a solution recommendation system according to an embodiment of this invention.

FIG. 2 is a block diagram for illustrating a physical configuration of the solution recommendation system according to the embodiment.

FIG. 3 is a diagram for illustrating a configuration example of the business organization category storage module according to the embodiment.

FIG. 4 is a diagram for illustrating a configuration example of the past sales activity history information storage module according to the embodiment.

FIG. 5 is a flow chart of processing executed by the solution recommendation system according to the embodiment.

FIG. 6 is a flow chart of similar case extraction processing according to the embodiment.

FIG. 7 is a diagram for illustrating changes of field information of a business organization according to the embodiment.

FIG. 8 is a flow chart of sales activity history registration processing according to the embodiment.

FIG. 9 is a diagram for illustrating an example of the sales recommendation information display screen according to the embodiment.

FIG. 10 is a diagram for illustrating an example of a sales result registration screen according to the embodiment.

### DETAILED DESCRIPTION OF THE PREFERRED EMBODIMENTS

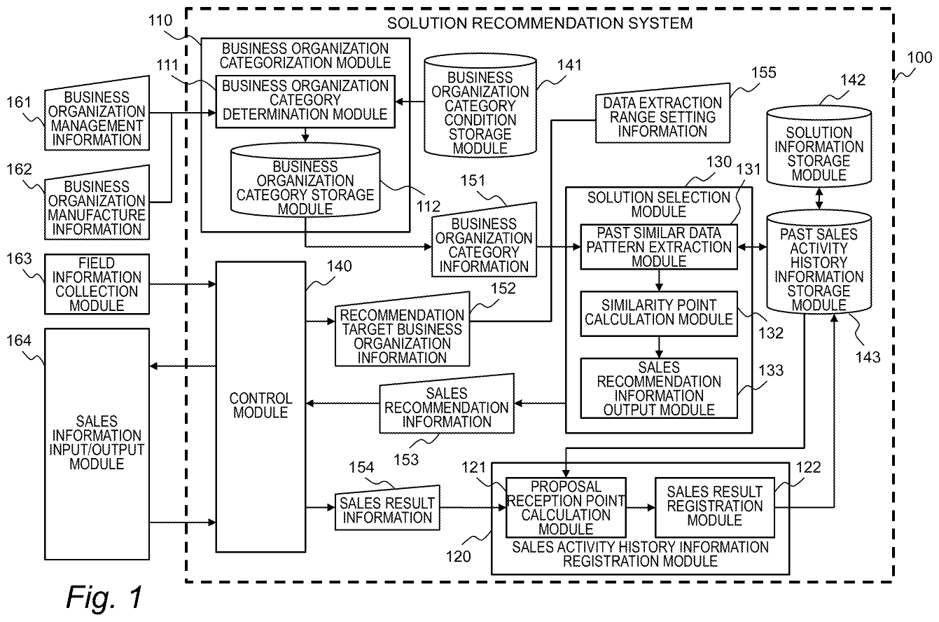

FIG. 1 is a block diagram for illustrating a logical configuration of a solution recommendation system 100 according to at least one embodiment of this invention.

The solution recommendation system 100 according to the at least one embodiment includes a business organization categorization module 110, a sales activity history information registration module 120, a solution selection module 130, a control module 140, a business organization category condition storage module 141, a solution information storage module 142, and a past sales activity history information storage module 143.

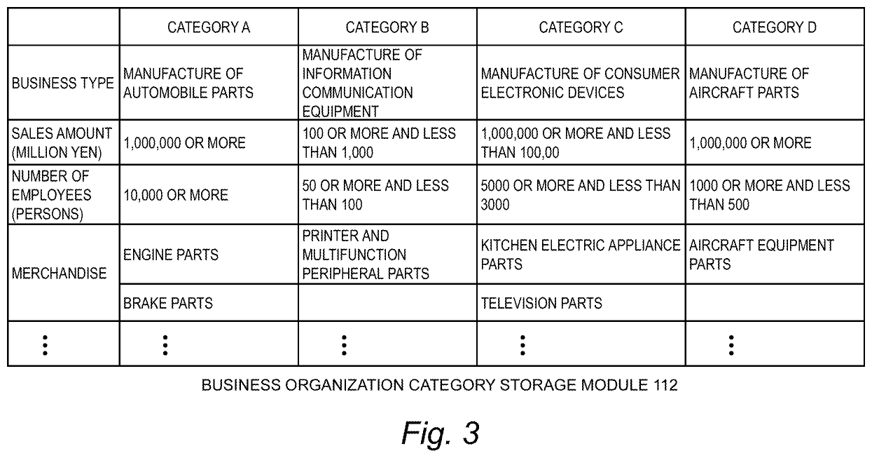

The business organization categorization module 110 includes a business organization category determination module 111 and a business organization category storage module 112, and categorizes business organizations similar in financial condition and manufacture attributes. The business organization category determination module 111 refers to the business organization category condition storage module 141, determines a category of a business organization with the use of business organization management information 161 and business organization manufacture information 162 which have been input, and stores the category in the business organization category storage module 112. The business organization category storage module 112 stores information of a business organization for which a category thereof has been determined by the business organization category determination module 111. Details of the business organization category storage module 112 are described with reference to FIG. 3.

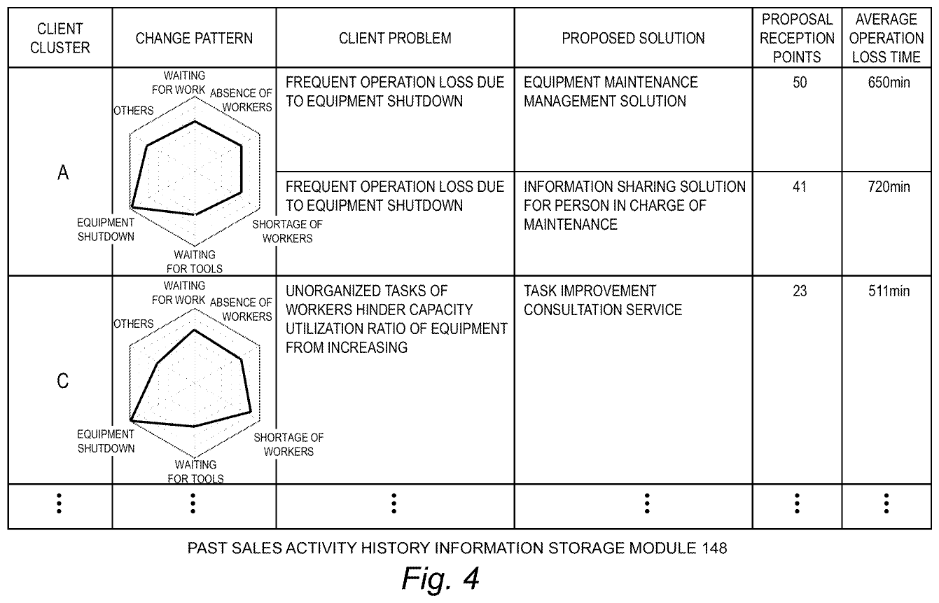

The sales activity history information registration module 120 includes a proposal reception point calculation module 121 and a sales result registration module 122, and registers a status reached by sales activities as a result of utilizing the solution recommendation system 100, a client's problem told by the client in hearing, and a solution desired by the client. The proposal reception point calculation module 121 calculates sales result points from sales result information 154 which has been input, and uses the calculated sales result points to calculate proposal reception points of a past solution proposal case stored in the past sales activity history information storage module 143. The sales result registration module 122 stores a result of a past sales activity in the past sales activity history information storage module 143. The solution information storage module 142 records an ID of a solution, which is a product, and a name and contents of the solution. The past sales activity history information storage module 143 stores a result of a past sales activity. Details of the past sales activity history information storage module 143 are described later with reference to FIG. 4.

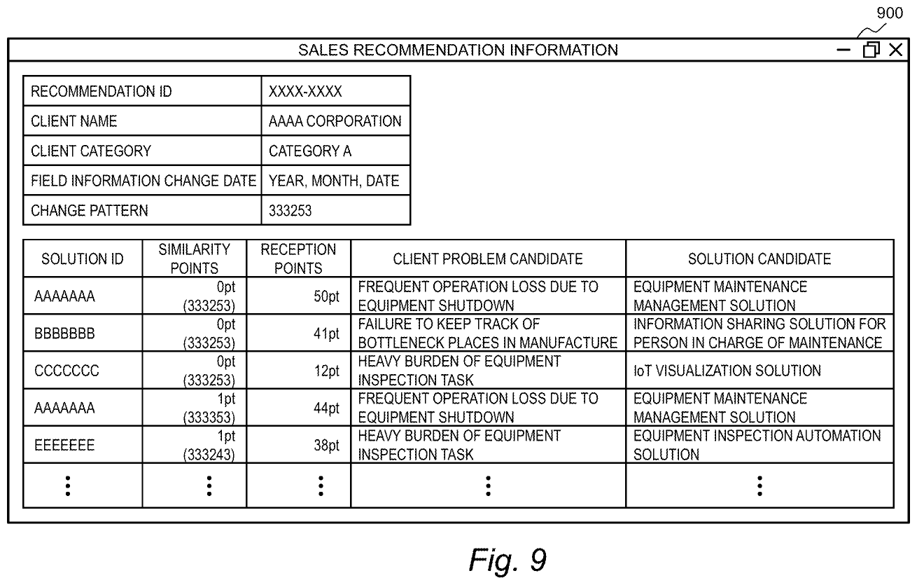

The solution selection module 130 includes a past similar data pattern extraction module 131, a similarity point calculation module 132, and a sales recommendation information output module 133, and estimates a client's problem and a solution from similarity to past changes in 4M data of a business organization classified in the same category. The past similar data pattern extraction module 131 extracts information within a range set by data extraction range setting information 155 (for example, a sales history information registration period or an operation loss time) from the past sales activity history information storage module 143. The similarity point calculation module 132 creates a change pattern of the extracted past sales activity history information, compares the change pattern of the past sales activity history information and a change pattern of field information, and calculates similarity points. The sales recommendation information output module 133 extracts a solution of past sales activity history information that is small in similarity points, and generates sales recommendation information 153 to be displayed on a sales recommendation information display screen which is illustrated in FIG. 9.

The control module 140 receives input of data from a sales information input/output module 164, processes the input data with function modules of the solution recommendation system 100, and outputs results of the processing from the sales information input/output module 164.

The data extraction range setting information 155 is information about a range of extraction of data from the past sales activity history information storage module 143 (for example, a sales history information registration period or an operation loss time).

The business organization management information 161 and the business organization manufacture information 162 are information about a business organization that is a client who receives a service provided by the solution recommendation system 100, and are public information (a registry book, financial statements, and the like) and non-public information provided by the business organization. The business organization management information 161 is information for classifying a business organization mainly by scale, and includes basic information (a company name, location, and the like) and financial information (a sales amount, a profit, and the like). The business organization manufacture information 162 is information for classifying a business organization mainly by merchandise or service, and includes information about a size of merchandise, a manufacturing method, an assembly accuracy, and the like.

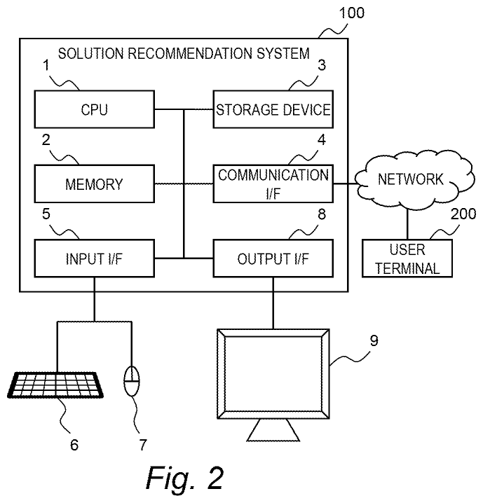

A field information collection module 163 is a sensor, a camera, or a similar terminal, or a manufacture management system which is installed in a manufacture site of each business organization, and collects field information (for example, so-called 4M data including Man, Machine, Method, and Material) from the manufacture site. The sales information input/output module 164 is a terminal apparatus (for example, a user terminal 200 illustrated in FIG. 2) for providing an interface through which sales information is input to and output from the solution recommendation system 100.

FIG. 2 is a block diagram for illustrating a physical configuration of the solution recommendation system 100 according to the at least one embodiment.

The solution recommendation system 100 according to the at least one embodiment is configured from a computer including a processor (CPU) 1, a memory 2, a storage device 3, and a communication interface 4. The solution recommendation system 100 may include an input interface 5 and an output interface 8.

The processor 1 is an arithmetic device for executing a program stored in the memory 2. The processor 1 executes various programs, to thereby implement functions provided by the modules (for example, the business organization categorization module 110, the sales activity history information registration module 120, the solution selection module 130, and the control module 140) of the solution recommendation system 100. Part of processing carried out by the processor 1 by executing programs may be executed by another arithmetic device (for example, ASIC, FPGA, or a similar piece of hardware).

The memory 2 includes a ROM, which is a non-volatile storage element, and a RAM, which is a volatile storage element. The ROM stores an unchanging program (for example, BIOS) among others. The RAM is a dynamic random access memory (DRAM) or a similar high-speed and volatile storage element, and temporarily stores a program executed by the processor 1 and data used when the program is executed.

The storage device 3 is a large-capacity and non-volatile storage device, such as a magnetic storage device (an HDD) or a flash memory (an SSD). The storage device 3 stores data (for example, the business organization category condition storage module 141, the solution information storage module 142, the past sales activity history information storage module 143, and the data extraction range setting information 155) used by the processor 1 when the processor 1 executes programs, and the programs executed by the processor 1. In other words, programs are read out of the storage device 3, loaded onto the memory 2, and executed by the processor 1, to thereby implement functions (for example, the business organization categorization module 110, the sales activity history information registration module 120, the solution selection module 130, and the control module 140) of the solution recommendation system 100.

The communication interface 4 is a network interface apparatus for controlling communication to and from other apparatus in accordance with a predetermined protocol.

The input interface 5 is an interface to which a keyboard 6 and a mouse 7, or other input apparatus are coupled to receive input from a user. The output interface 8 is an interface to which a display apparatus 9 and a printer (not shown) or other output apparatus are coupled to output a result of executing a program in a format visually recognizable to the user. The user terminal 200 coupled to the solution recommendation system 100 via a network may provide an input apparatus and an output apparatus. In this case, the solution recommendation system 100 may have a function of a Web server and be accessed by the user terminal 200 in accordance with a predetermined protocol (for example, http).

A program executed by the processor 1 is provided via a removable medium (a CD-ROM, a flash memory, or the like) or a network to the solution recommendation system 100, and is stored in the non-volatile storage device 3 which is a non-transitory storage medium. It is therefore recommended that the solution recommendation system 100 include an interface through which data is read out of a removable medium.

The solution recommendation system 100 is a computer system configured on a single physical computer or on a plurality of logically or physically configured computers, and may operate on a virtual machine built on a plurality of physical computer resources. For example, the business organization categorization module 110, the sales activity history information registration module 120, the solution selection module 130, and the control module 140 may separately operate on different physical or logical computers, or a combination of some of those modules may operate on a single physical or logical computer.

FIG. 3 is a diagram for illustrating a configuration example of the business organization category storage module 112.

The business organization category storage module 112 is information referred to by the business organization categorization module 110 in order to categorize similar business organizations, and records a business type, a sales amount, the number of employees, a merchandise, and other types of data that characterize categories.

FIG. 4 is a diagram for illustrating a configuration example of the past sales activity history information storage module 143.

The past sales activity history information storage module 143 records, for each client cluster, a client cluster, a change pattern, a client problem, a proposed solution, proposal reception points, an average operation loss time, and other types of data about sales. The change pattern is change ratios categorized by items of field information of business organizations, and is expressed in the form of a string of numbers or a radar chart. For example, change ratios of items “waiting for work,” “absence of workers,” “shortage of workers,” “waiting for tools,” “equipment shutdown,” and “others” may be categorized in a manner described later and may be expressed in the form of a radar chart. The proposed solution is a solution proposed to clients of that cluster, and is recorded for each client problem. The proposal reception points are points that are a digitized progress or outcome of sales activities concerning the proposed solution, with respect to a plurality of clients included in the client cluster. The average operation loss time is an average value of client-by-client values of specific field information (operation loss) that serves as an index for extracting target data of solution recommendation.

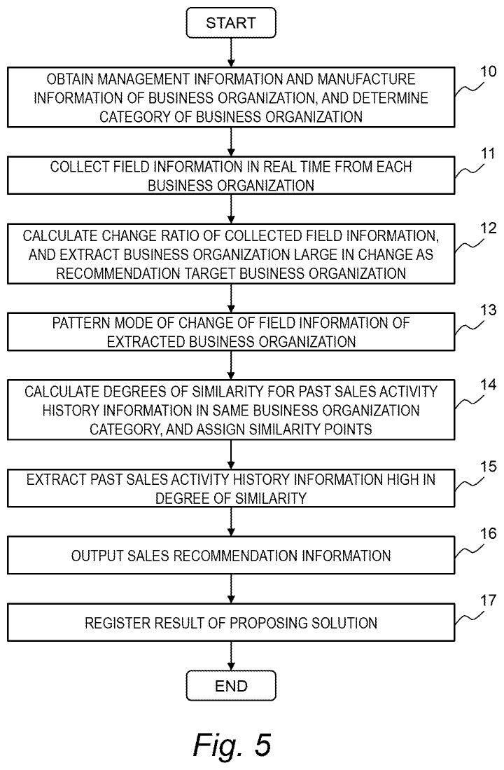

FIG. 5 is a flow chart of processing executed by the solution recommendation system 100.

First, the business organization category determination module 111 obtains the business organization management information 161 and the business organization manufacture information 162 input from the input interface 5, determines a category of a business organization, and outputs business organization category information 151 (Step 10). The business organization category information 151 is information in which a business organization ID and a determined category are associated with each other.

Next, the control module 140 collects field information in real time from the field information collection module 163 installed at each business organization (Step 11), calculates the change ratio of the collected field information, and extracts a business organization for which changes are large as a recommendation target business organization (Step 12). The control module 140 patterns a mode of changes of the field information of the extracted business organization (Step 13).

Next, the similarity point calculation module 132 calculates a degree of similarity to past sales activity history information of the same business organization category, and assigns similarity points (Step 14).

Next, the sales recommendation information output module 133 extracts a piece of past sales activity history information to which the degree of similarity is high from the past sales activity history information storage module 143 (Step 15), and outputs the sales recommendation information 153 via the control module 140 to the sales information input/output module 164 (Step 16).

Then, the sales activity history information registration module 120 registers a solution proposal result input to the sales information input/output module 164 (Step 17).

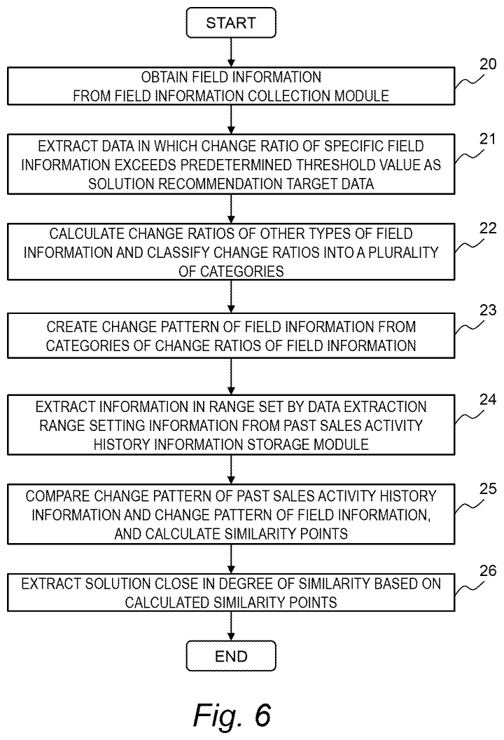

FIG. 6 is a flow chart of similar case extraction processing, and is an illustration of details of Step 11 to Step 15 of FIG. 5.

First, the control module 140 obtains field information from the field information collection module 163 (Step 20).

The control module 140 next extracts data in which the change ratio of a specific piece of field information exceeds a predetermined threshold value (for example, the operation loss changes by ±5%) as solution recommendation target data (Step 21).

The control module 140 next calculates the change ratios of other types of field information, and classifies the change ratios into a plurality of categories by predetermined threshold values (Step 22). For example, the change ratios of “waiting for work,” “absence of workers,” “shortage of workers,” “waiting for tools,” “equipment shutdown,” and “others” are calculated and categorized into five categories that are 100% or more, equal to or more than 50% and less than 100%, equal to or more than −30% and less than 50%, equal to or more than −50% and less than −30%, and less than −50%.

The control module 140 next creates a change pattern of the field information from the categories of the change ratios of the field information (Step 23). For example, when “waiting for work” belongs to Category 3, “absence of workers” belongs to Category 3, “shortage of workers” belongs to Category 3, “waiting for tools” belongs to Category 2, “equipment shutdown” belongs to Category 5, and “others” belongs to Category 3, a change pattern “333253” is created. In other words, a change pattern is a value aggregating characteristics of the field information.

The control module 140 then outputs recommendation target business organization information 152 of a business organization to which a solution is to be recommended to the past similar data pattern extraction module 131.

Next, the past similar data pattern extraction module 131 extracts a piece of past sales activity history information that is within a range set by the data extraction range setting information 155 and that matches the business organization category information 151 and the recommendation target business organization information 152 from the past sales activity history information storage module 143 (Step 24). Through extraction of past sales activity history information that is within a range set by the data extraction range setting information 155 from the past sales activity history information storage module 143, old pieces of sales history information can be excluded when, for example, a sales history information registration period is specified.

Next, the similarity point calculation module 132 creates a change pattern of the extracted past sales activity history information, compares the change pattern of the past sales activity history information and a change pattern of field information, and calculates similarity points (Step 25). Similarity points are calculated by, for example, adding 1 point each time there is a difference of 1 between numbers at a digit. In this method, similarity points of the change pattern “333253” and a change pattern “334252” are 2 points.

Next, the sales recommendation information output module 133 extracts a solution of past sales activity history information that is small in similarity points (that has, for example, similarity points equal to or less than 2), and generates sales recommendation information 153 to be displayed on the sales recommendation information display screen which is illustrated in FIG. 9 (Step 26).

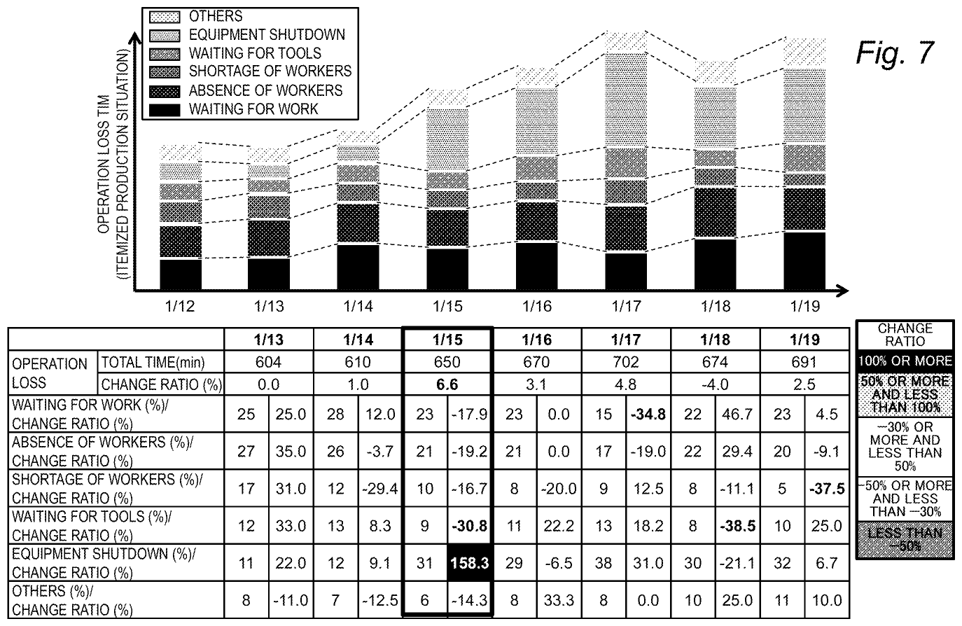

A specific example of the similar case extraction processing is described with reference to FIG. 7. FIG. 7 is a diagram for illustrating changes of field information of a business organization, and change ratios of production situations are illustrated as changes of the field information.

A change of ±5% in operation loss is used as a change ratio of a specific piece of field information that serves as an index for extracting solution recommendation target data.

In the illustrated data, the operation loss time on January 15 has recorded an increase of 6.6%, which exceeds the threshold value of ±5%. The field information on January 15 is therefore used to estimate a client problem.

First, the total operation loss time on January 15 is 650 minutes, and change patterns in which the average operation loss time is within a predetermined range are accordingly extracted by referring to the past sales activity history information storage module 143. This is because business organizations that greatly differ from each other in the value of the operation loss time may be similar to each other in other types of field information but are dissimilar in production method and the like to begin with, and are therefore to be proposed with different solutions.

From among the change patterns extracted based on the total operation loss time, past cases similar in a change pattern of other types of field information are preferentially extracted.

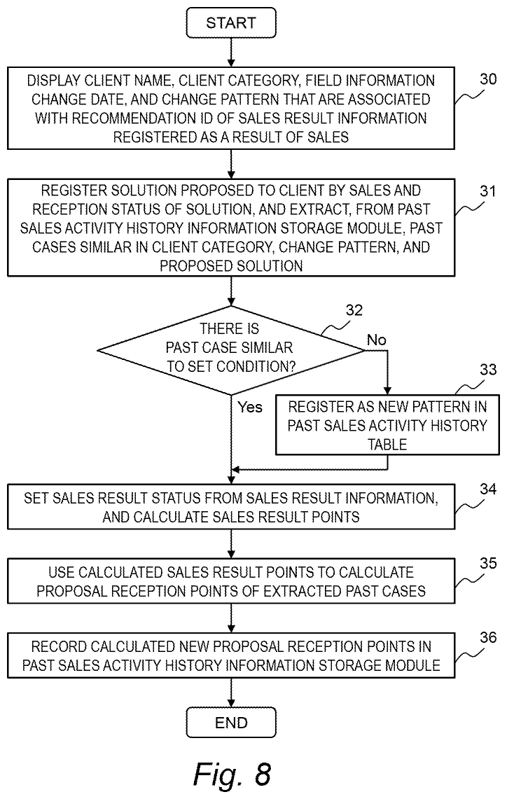

FIG. 8 is a flow chart of sales activity history registration processing.

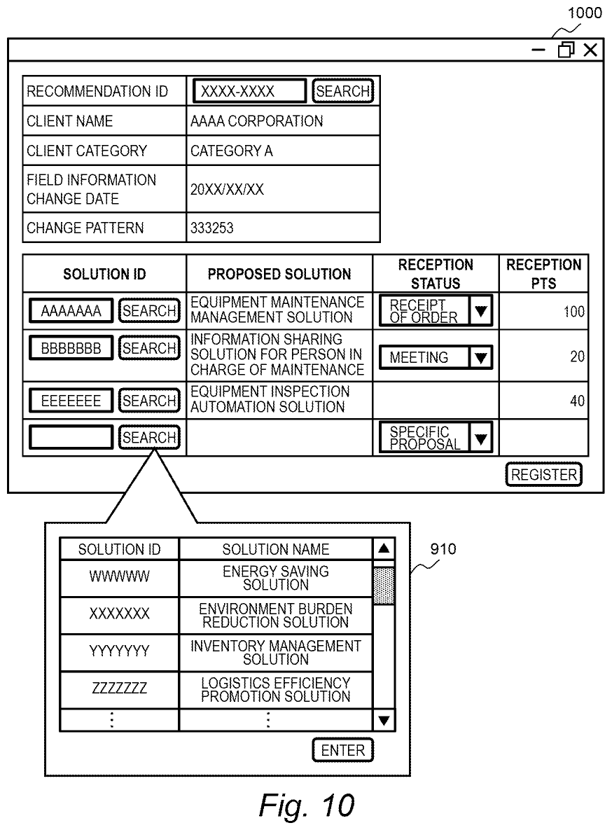

When a recommendation ID is input from the sales information input/output module 164, the sales activity history information registration module 120 first obtains a client name, a client category, a field information change date, and a change pattern that are associated with the input recommendation ID from the past sales activity history information storage module 143, and displays the obtained information on a sales result registration screen which is illustrated in FIG. 10 (Step 30).

Next, when a solution ID and a reception status of a proposed solution are input from the sales information input/output module 164, the sales activity history information registration module 120 obtains a proposed solution name and reception points that are associated with the input solution ID from the past sales activity history information storage module 143, and displays the obtained information on the sales result registration screen which is illustrated in FIG. 10. The solution ID and the reception status of the proposed solution are then registered in the past sales activity history information storage module 143, and past cases similar in client category, change pattern, and proposed solution are extracted from the past sales activity history information storage module 143 (Step 31). A sub-screen with a list of solution IDs and solution names from which a solution ID to be input can be selected may be displayed to prompt input of a solution ID.

The sales activity history information registration module 120 next determines whether there is a past case similar to a set condition (Step 32). When it is determined that there is no past case similar to the set condition, the current case is registered in a past sales activity history table as a new pattern (Step 33), and the process proceeds to Step 34. When it is determined that there is a past case similar to the set condition, on the other hand, the process skips Step 33 and proceeds to Step 34.

The sales activity history information registration module 120 next sets, in the past sales activity history information storage module 143, a sales result status of the sales result information 154 that has been input, and the proposal reception point calculation module 121 calculates sales result points from the input sales result information 154 (Step 34). The sales result points are a numerical value determined based on a progress from a sales activity and consideration on the client's part to receipt of order. In a preferred example of sales result points, rejection of an appointment is 0 points, realization of a meeting is 20 points, specific proposal is 40 points, quotation is 60 points, consideration/request for decision on the client's part is 80 points, and receipt of order is 100 points.

The sales activity history information registration module 120 next uses the calculated sales result points to calculate proposal reception points of the extracted past cases (Step 35). The proposal reception points are an average value of past sales result points.

The sales activity history information registration module 120 next records the calculated new proposal reception points in the past sales activity history information storage module 143 (Step 36).

FIG. 9 is a diagram for illustrating an example of the sales recommendation information display screen on which the sales recommendation information 153 is displayed.

The sales recommendation information 153 includes a recommendation ID, which is unique identification information of a recommendation, a client name indicating a name of a client to whom a solution is recommended, a client category indicating a category of the client, a field information change date indicating a date at which the client's field information has changed, and a change pattern indicating a pattern of changes of other types of field information that have been brought about by the detected change of field information. The sales recommendation information 153 further includes a solution ID of a solution to be proposed to the client, similarity points of the solution, reception points, a client problem candidate, and a solution candidate.

FIG. 10 is a diagram for illustrating an example of a sales result registration screen 1000.

The sales result registration screen includes a recommendation information display area and a solution information display area. The recommendation information display area includes a recommendation ID input field to which a recommendation ID is input from the sales information input/output module 164, and a client name, a client category, a field information change date, and a change pattern that are associated with the input recommendation ID. The solution information display area is an area to which information about a solution proposed to the client is input, and includes a solution ID input field, a solution name display field, a reception status input field, and a reception point display field.

As described above, according to the recommendation system of the at least one embodiment, a problem of a client is analyzed from real time field information (4M data) of a field site, and an appropriate solution can accordingly be recommended to manufacturing industries. In addition, a precision with which a client problem is analyzed from a change of field information can be improved by feeding back sales results.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A recommendation system for selecting a product to be proposed to a client, the recommendation system comprising:
an arithmetic device configured to execute predetermined processing; and
a storage device accessible to the arithmetic device;
having a selection module configured to estimate a product to be recommended to a client,
the selection module being configured to:
calculate a change ratio at which, out of pieces of collected field information, a specific piece of field information changes;
extract a business organization high in the change ratio of the specific piece of field information as a target client; and
estimate, from similarity in the change of the field information of the client, a product to be recommended to the target client.

2. The recommendation system according to claim 1, further having
a categorization module configured to determine a category of a client by similarity in attributes of the client, and
wherein the selection module is configured to estimate, from similarity in changes of field information of clients included in the same category, a product to be recommended to the client.

3. The recommendation system according to claim 2, further having:
a past sales activity history information storage module configured to store data indicating possibility at which a client belonging to the category employs the product and which is calculated based on a status reached by sales activities of the product; and
a sales activity history information registration module configured to update the data stored in the past sales activity history information storage module,
wherein the selection module is configured to estimate, by referring to the past sales activity history information storage module, a product high in possibility of employment as a product to be recommended to the client, and
wherein the sales activity history information registration module is configured to update a value indicating the possibility of employment by input a sales activity performed to a client.

4. The recommendation system according to claim 3,
wherein the storage device is configured to store data extraction range setting information determining a range of a sales activity history to be extracted from the past sales activity history information storage module, and
wherein the selection module is configured to:
extract, in the range determined by the data extraction range setting information, the sales activity history from the past sales activity history information storage module; and
estimate, based on the extracted sales activity history, a product to be recommended to the client.

5. The recommendation system according to claim 1, wherein the selection module is configured to determine similarity in the change of the field information of the client, by change ratios at which other pieces of field information out of the pieces of collected field information change, and which change in relation to the change ratio of the specific piece of field information.

6. The recommendation system according to claim 1, wherein the selection module is configured to determine similarity in the change of the field information of the client, by taking into consideration similarity in value of the specific piece of field information.

7. A product recommendation method for selecting a product to be proposed to a client by a recommendation system,
the recommendation system including an arithmetic device configured to execute predetermined processing and a storage device accessible to the arithmetic device,
the product recommendation method comprising the steps of:
estimating, by the arithmetic device, a product to be recommended to a client;
calculating, by the arithmetic device, a change ratio at which, out of pieces of collected field information, a specific piece of field information changes;
extracting, by the arithmetic device, a business organization high in the change ratio of the specific piece of field information as a target client; and
estimating, by the arithmetic device, from similarity in the change of the field information of the client, a product to be recommended to the target client.

8. The product recommendation method according to claim 7, further comprising the steps of:
determining, by the arithmetic device, a category of a client by similarity in attributes of the client; and
estimating, by the arithmetic device, from similarity in changes of field information of clients included in the same category, a product to be recommended to the client.

9. The product recommendation method according to claim 8, further comprising the steps of:
estimating, by the arithmetic device, by referring to past sales activity history information, a product high in possibility of employment as a product to be recommended to the client; and
updating, by the arithmetic device, a value indicating the possibility of employment by input a sales activity performed to a client.

10. The product recommendation method according to claim 9, further comprising the steps of:
extracting, by the arithmetic device, in a range determined by data extraction range setting information, a sales activity history from the past sales activity history information storage module; and
estimating, by the arithmetic device, based on the extracted sales activity history, a product to be recommended to the client.

11. The product recommendation method according to claim 7, further comprising the step of determining, by the arithmetic device, similarity in the change of the field information of the client, by change ratios at which other pieces of field information out of the pieces of collected field information change, and which change in relation to the change ratio of the specific piece of field information.

12. The product recommendation method according to claim 7, further comprising the step of determining, by the arithmetic device, similarity in the change of the field information of the client, by taking into consideration similarity in value of the specific piece of field information.
